(19) United States
(12) Patent Application Publication
(10) Pub. No.: US 2017/0066856 A1
(43) Pub. Date: Mar. 9, 2017

(54) MULTILAYER FILM RANDOM PROPYLENE-ETHYLENE COPOLYMERS

(71) Applicant: BASELL POLIOLEFINE ITALIA S.R.L., MILANO (IT)

(72) Inventors: PAOLA MASSARI, FERRARA (IT); FABRIZIO PIEMONTESI, FERRARA (IT); GIANNI VITALE, FERRARA (IT); CAROLINE CATHELIN, FERRARA (IT); GIAMPIERO MORINI, FERRARA (IT); MARCO CIARAFONI, FERRARA (IT); CLAUDIO CAVALIERI, FERRARA (IT); ANDREA ISATI, FERRARA (IT)

(73) Assignee: BASELL POLIOLEFINE ITALIA S.R.L., MILANO (IT)

(21) Appl. No.: 15/309,155

(22) PCT Filed: Apr. 28, 2015
(86) PCT No.: PCT/EP2015/059246

§ 371 Date: Nov. 4, 2016

(30) Foreign Application Priority Data
May 6, 2014 (EP) 14167178.4
Apr. 17, 2015 (EP) 15164015.8

(51) Int. Cl. C08F 210/06

(52) U.S. Cl. CPC C08F 210/06

(57) ABSTRACT

The present disclosure relates to a multilayer film characterized by one or more skin layers comprising propylene/ethylene copolymers characterized by the following features: an ethylene derived units content of between 1.0 wt % and 15.0% wt %; and a molecular weight distribution (MWD), expressed in terms of Mw/Mn, of greater than 4.0;

a content of xylene soluble fraction (XS) and an ethylene derived units content (C2) that fulfills the following relationship:

XS<1.0296·e^{0.435C2}

where XS is the percentage by weight of the fraction soluble in xylene at 25° C., and C2 is the percentage by weight of ethylene units in the copolymers as determined via NMR.

### FIELD OF THE INVENTION

The present disclosure relates to multilayer films comprising at least a top or bottom layer of a random propylene/ethylene copolymer(s) comprising excellent properties such as low xylene-solubles content, improved optical properties and printability.

### BACKGROUND OF THE INVENTION

Propylene copolymers containing from 0.1 to 10% by weight of ethylene, in which the comonomer is randomly distributed in the polypropylene chain, are generally referred to as random propylene copolymers. Compared with propylene homopolymers, the random propylene copolymers have molecular structures which are modified by the presence of a comonomer, leading to a substantially lower degree of crystallinity. As a result, random copolymers generally have lower melting temperatures with respect to propylene homopolymers as well as lower sealing temperatures and moduli of elasticity.

However, the introduction of the comonomer into the polypropylene chain can lead to significant increases in the fraction of polymer which is soluble in xylene at room temperature, e.g. around 25° C., where the soluble polymer is mainly composed of low molecular weight chains and contains percentages of comonomer which are higher than the average content of comonomer calculated on the basis of the whole polymer. The amount of xylene soluble fraction generally increases as the content of comonomer in the copolymer increases and, beyond defined limits, precludes the use of the copolymers in certain commercial applications, for example in the preparation of films for wrapping food, unless elimination of the soluble fraction is performed. The presence of relevant amounts of the xylene soluble fractions decreases the flowability of the polymer granules, thereby making operations such as discharging and transferring the polymer difficult and giving rise to operational problems in the polymerization plant. Moreover, the presence of significant amounts of xylene soluble fractions in copolymers can lead to the deterioration of optical properties due to the migration of these fractions to the surface (referred to as blooming) as well as to a worsening of the organoleptic properties.

It is known in the art that random propylene copolymers with improved comonomer distribution are obtainable using single-site catalysts.

For instance, WIPO Pat. App. Pub. No. WO 2007/45600 describes random propylene copolymers having high melt flow rates (MFRs) for injection molding and melt blowing applications.

The copolymers described therein have a melt flow rate ranging from 90 to 3000 g/10 min and a molecular weight distribution of lower than 4. The material is obtained by using metallocene-based catalyst system. However, even if the xylene soluble fraction of the material is less than 2.2, additional features such as high melt flow rate and narrow molecular weight distribution reduce its usefulness for applications such as cast films.

WIPO Pat. App. Pub. No. WO 2006/120190 describes random propylene/ethylene copolymers having an ethylene content ranging from 4.5 to 7 wt % and an Mw/Mn value of lower than 4. The copolymers described in this document shows very low levels of xylene solubles after visbreaking; however, the xylene solubles of the ex reactor polymer are comparatively high.

U.S. Pat. No. 6,365,685 (and WIPO Pat. App. Pub. No. WO 97/31954) relates to propylene random copolymers obtained by using a phthalate based catalyst in combination with certain 1,3-diethers as external donors. The random propylene polymers described therein are improved with respect to similar polymers obtained using the same phthalate-based Ziegler-Natta (Z-N) catalysts in combination with silanes as the external donors. However, the properties of the random copolymers still need to be improved, particularly if the xylene solubles content reported in the cited patent is determined by a method which comprises dissolving the whole sample at the xylene boiling point, lowering the temperature of the solution to 0° C. and then let the temperature raise up until 25° C. This method, as shown in the “Comparative Examples” of the document, gives rise to lower value of xylene solubles.

### SUMMARY OF THE INVENTION

It has surprisingly been found by the applicants that multilayer films having at least a skin layer comprising a propylene ethylene copolymer have beneficial features and obtained by heterogeneous catalysts can have improved sealing initiation temperature and dyne retention and improved organoleptics.

An object of the present disclosure is a multilayer film having at least a skin layer comprising one or more propylene ethylene copolymers comprising:

ethylene derived units between 1.0 wt % and 15.0 wt %;

a molecular weight distribution (MWD), expressed in terms of Mw/Mn, of greater than 4.0; and

a content of xylene soluble fraction (XS) and ethylene derived units content (C2) that fulfills the following relationship:

XS<1.0296·e^{0.435C2}

where XS is the percentage by weight of the fraction soluble in xylene at 25° C.; and C2 is the percentage by weight of ethylene units in the copolymers determined via NMR.

### DETAILED DESCRIPTION OF THE INVENTION

The multilayer film is characterized by having at least a skin layer comprising a propylene ethylene copolymers comprising:

ethylene derived units content between 1.0 wt % and 15.0 wt %; between 1.0 wt % and 10.0 wt %; between 2.2 wt % and 7.1 wt %; between 2.7 wt % and 6.3 wt %; and between 2.9 wt % and 4.8 wt %;

a molecular weight distribution (MWD), expressed in terms of Mw/Mn, greater than 4.0 and lower than 10;

the content of xylene soluble fraction (XS) and ethylene derived units (C2) that fulfills the following relationship:

XS<1.0296·e^{0.435C2}

including where:

XS<0.969·e^{0.435C2}

where XS is the percentage by weight of the fraction soluble in xylene at 25° C.; and C2 is the percentage by weight of ethylene units in the copolymers as determined via NMR.

The propylene ethylene copolymer of the present disclosure is defined as containing only propylene and ethylene comonomers.

In some embodiments, the Melt Flow Rate (MFR 230° C., 2.16 kg) of the copolymers as a reactor grade (i.e., copolymers that have not been subject to chemical or physical visbreaking) ranges from 2.0 to 25.0 g/10 min, including from 3.0 to 20.0 g/10 min; and from 4.0 to 18.0 g/10 min;

In certain embodiments, the content of the xylene soluble fraction (XS) and ethylene content (C2) fulfill the following relationship:

XS<(C2×2.1)−2.4

where:
XS=% by weight of the fraction soluble in xylene at 25° C. as determined according to the method given in the characterization section;
C2=% by weight of ethylene derived units content in the copolymer determined via NMR according to the method given in the characterization section;
The relationship may be further defined as:

XS<(C2×2.1)−2.6;

further defined as:

XS<(C2×2.1)−2.8;

and still further defined as:

XS<(C2×2.1)−3.0.

In some embodiments, in the propylene/ethylene copolymer the 2,1 propylene insertions cannot be detected via ¹³C NMR according to the procedure reported in the characterizing section.

In certain embodiments, in the propylene ethylene copolymer the content of propylene units in form of isotactic triads (mm %) determined via ¹³C NMR is higher than 98.3%, including higher than 98.5%.

In some embodiments, the multilayer films of the present disclosure are characterized by having at least one skin layer comprising the propylene ethylene copolymer of the present disclosure, while the remaining layers can be formed from any material known in the art for use in multilayer films or in film-coated products. For example, each layer can be formed from a polypropylene homopolymer or copolymer, a polyethylene homopolymer or copolymer and other kind of polymers such as EVA and EVOH

The combination and number of layers comprising the multilayer structure is, in some embodiments, from 3 to 11 layers, including 3 to 9 layers, 3 to 7 layers, and 3 to 5 layers, where combinations including A/B/A, A/B/C, AB/CB/A, A/B/C/D/C/B/A layering arrangements are possible, provided that at least one skin layer A comprises the propylene ethylene copolymer of the present disclosure.

In certain embodiments, the number of layers comprising the multilayer film of the present disclosure is 3 or 5, wherein at least one skin layer comprises the propylene/ethylene copolymer of the present disclosure. In some embodiments, the layering structure is A/B/A or A/B/C, wherein A is the propylene/ethylene copolymer of the present disclosure.

In some embodiments, the skin layer is the top layer and/or the bottom layer of a multilayer film.

In further embodiments, in the multilayer film of the present disclosure the top layer and the bottom layer of the film comprise the propylene/ethylene copolymer of the present disclosure.

The multilayer film of the present disclosure is characterized by a low seal initiation temperature (SIT) and a good dyne retention, which renders the film suitable for printing even after, for example plasma or corona treatments have been applied.

In some embodiments, the difference between the melting point and the SIT is higher than 17° C.; such as higher than 18° C. and higher than 19° C.

The propylene ethylene copolymer herein disclosed can be prepared by a process comprising polymerizing propylene with ethylene, in the presence of a catalyst comprising the product of the reaction between:

(i) a solid catalyst component comprising Ti, Mg, Cl, and an electron donor compound comprising from 0.1 to 50% wt. of bismuth (Bi) with respect to the total weight of the solid catalyst component;
(ii) an alkylaluminum compound; and
(iii) an electron-donor compound (external donor).

In some embodiments, in the catalyst component the content of Bi ranges from 0.5 to 40% wt., such as from 1 to 35% wt., from 2 to 25% wt. and from 2 to 20% wt.

The particles of solid component have a substantially spherical morphology and an average diameter ranging between 5 and 150 μm, including from 20 to 100 μm and from 30 to 90 μm. As used herein, “particles having substantially spherical morphology” means the ratio between the greater axis and the smaller axis is equal to or lower than 1.5, such as lower than 1.3.

In some embodiments, the amount of magnesium (Mg) in the solid catalyst component ranges from 8 to 30% wt., such as from 10 to 25% wt.

In certain embodiments, the amount of Ti in the solid catalyst component ranges from 0.5 to 5% wt., including from 0.7 to 3% wt.

In additional embodiments, internal electron donor compounds are selected from alkyl and aryl esters of optionally substituted aromatic polycarboxylic acids such as esters of benzoic and phthalic acids. Examples of such esters are n-butylphthalate, di-isobutylphthalate, di-n-octylphthalate, ethyl-benzoate and p-ethoxy ethyl-benzoate.

In further embodiments, the Mg/Ti molar ratio in the solid catalyst component is equal to or higher than 13, such as in the range of 14-40, including from 15 to 40. In some embodiments, the Mg/donor molar ratio in the solid catalyst component is higher than 16, higher than 17 and ranging from 18 to 50.

The Bi atoms may derive from one or more Bi compounds not having Bi-carbon bonds. In certain embodiments, the Bi compounds can be selected from Bi halides, Bi carbonates, Bi acetates, Bi nitrates, Bi oxides, Bi sulfates and Bi sulfides. Compounds in which Bi has a valency of +3 may be used, such as Bi trichloride and Bi tribromide.

The preparation of the solid catalyst component can be carried out according to several methods.

According to one method the solid catalyst component can be prepared by reacting a titanium compound of the formula Ti(OR)_{q-y}X_{y}, where q is the valence of titanium and y is a number between 1 and q, such as TiCl₄, with a magnesium chloride from an adduct of the formula MgCl₂.pROH, where p is a number between 0.1 and 6, such as from 2 to 3.5, and R is a hydrocarbon radical having 1-18 carbon atoms. The adduct can be prepared in spherical form by mixing alcohol and magnesium chloride, operating under stirring conditions at the melting temperature of the adduct (100-130° C.). The adduct may then be mixed with an inert hydrocarbon immiscible with the adduct, thereby creating an emulsion which is quickly quenched, causing the solidification of the adduct into spherical particles. Examples of spherical adducts prepared according to this procedure are described in U.S. Pat. Nos. 4,399,054 and 4,469,648. The adduct can be directly reacted with a Ti compound or it can be subjected to thermal controlled dealcoholation (80-130° C.) to obtain an adduct in which the number of moles of alcohol is generally lower than 3, such as between 0.1 and 2.5. The reaction with the Ti compound can be carried out by suspending the adduct (which is optionally dealcoholated) in cold TiCl₄ (generally at a temperature of about 0° C.); the mixture is then heated up to 80-130° C. and kept at this temperature for 0.5-2 hours. The treatment with TiCl₄ can be carried out one or more times. The electron donor compound can be added in the desired ratios during the treatment with TiCl₄.

Several ways are available to add one or more Bi compounds during the catalyst preparation. According to one embodiment, the Bi compound(s) is/are incorporated directly into the MgCl₂.pROH adduct during its preparation. In some embodiments, the Bi compound can be added at the initial stage of adduct preparation by mixing it with MgCl₂ and the alcohol. Alternatively, it can be added to the molten adduct before the emulsification step. The amount of Bi introduced ranges from 0.1 to 1 mole per mole of Mg in the adduct. Bi compound(s) that may be incorporated directly into the MgCl₂.pROH adduct are Bi halides such as BiCl₃.

The alkyl-Al compound (ii) may be chosen from among the trialkyl aluminum compounds such as for example triethylaluminum, triisobutylaluminum, tri-n-butylaluminum, tri-n-hexylaluminum and tri-n-octylaluminum. It is also possible to use alkylaluminum halides, alkylaluminum hydrides or alkylaluminum sesquichlorides, such as AlEt₂C1 and Al₂Et₃Cl₃, possibly in mixture with the above cited trialkylaluminums. The Al/Ti ratio is higher than 1 and is generally between 50 and 2000.

Suitable external electron-donor compounds include silicon compounds, ethers, esters, amines, heterocyclic compounds, 2,2,6,6-tetramethylpiperidine and ketones.

A class of external donor compounds for use in the present technology is silicon compounds of the formula (R₆)ₐ(R₇)_{b}Si(OR₈)_{c}, where a and b are integers from 0 to 2, c is an integer from 1 to 4 and the sum (a+b+c) is 4; R₆, R₇, and R₈, are alkyl, cycloalkyl or aryl radicals with 1-18 carbon atoms optionally containing heteroatoms. In some embodiments, silicon compounds in which a is 1, b is 1, c is 2, at least one of R₆ and R₇ is selected from branched alkyl, cycloalkyl or aryl groups with 3-10 carbon atoms optionally containing heteroatoms and R₈ is a C₁-C₁₀ alkyl group, such as methyl, may be used. Examples of such silicon compounds are methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)-(2-ethylpiperidinyl)-dimethoxysilane and methyl(3,3,3-trifluoro-n-propyl)dimethoxysilane. Silicon compounds in which a is 0, c is 3, R₇ is a branched alkyl or cycloalkyl group, optionally containing heteroatoms, and R₈ is methyl may be used. Examples of such silicon compounds are cyclohexyltrimethoxysilane, t-butyltrimethoxysilane and thexyltrimethoxysilane.

In some embodiments, the electron donor compound (iii) is used in such an amount as to produce a weight ratio between the organoaluminum compound and the electron donor compound (iii) of from 2.5 to 500, such as from 3 to 300 and from 3.5 to 100.

The polymerization process can be carried out according to known techniques, for example slurry polymerization, using an inert hydrocarbon solvent as a diluent, or bulk polymerization using a liquid monomer (for example, propylene) as a reaction medium. Moreover, it is possible to carry out the polymerization process in gas-phase operating in one or more fluidized or mechanically agitated bed reactors.

The polymerization is generally carried out at a temperature of 20 to 120° C., including from 40 to 80° C. When the polymerization is carried out in gas-phase, the operating pressure may be between 0.5 and 5 MPa, such as between 1 and 4 MPa. In bulk polymerizations in accordance with the present disclosure the operating pressure may be between 1 and 8 MPa, including between 1.5 and 5 MPa. Hydrogen may be used as a molecular weight regulator.

The following examples are given in order to better illustrate the disclosure but not limit it in any way.

### EXAMPLES

### Characterizations

Determination of Mg, Ti

The determination of Mg and Ti content in the solid catalyst component is carried out via inductively coupled plasma emission spectroscopy on an “I.C.P Spectrometer ARL Accuris”. The sample was prepared by analytically weighing, in a “Fluxy” platinum crucible”, 0.1-0.3 grams of catalyst and 2 grams of lithium metaborate/tetraborate in a 1/1 mixture. After addition of some drops of potassium iodide (KI) solution, the crucible is inserted in a special apparatus “Claisse Fluxy” for the complete burning. The residue is collected with a 5% v/v HNO₃ solution and then analyzed via ICP at the following wavelengths: Magnesium, 279.08 nm; Titanium, 368.52 nm.

Determination of Bi

The determination of Bi content in the solid catalyst component is carried out via inductively coupled plasma emission spectroscopy on “I.C.P Spectrometer ARL Accuris”.

The sample was prepared by analytically weighing, in a 200 cm³ volumetric flask, 0.1-0.3 grams of catalyst. After slow addition of both ca. 10 milliliters of 65% v/v HNO₃ solution and ca. 50 cm³ of distilled water, the sample undergoes digestion for 4-6 hours. The volumetric flask is diluted to the 200 cm³ mark with deionized water. The resulting solution is directly analyzed via ICP at the following wavelength: Bismuth, 223.06 nm.

Determination of Internal Donor Content

The determination of the content of internal donor in the solid catalytic compound was done through gas chromatography. The solid component was dissolved in acetone, an internal standard was added, and a sample of the organic phase was analyzed in a gas chromatograph, to determine the amount of donor present at the starting catalyst compound.

Determination of X.I.

The xylene soluble fraction was measured according to ISO 16152 (2005, but with the following deviations (between brackets as prescribed by the ISO 16152 procedure).

i—The solution volume is 250 ml;
ii—During the precipitation stage at 25° C. for 30 min, the solution, for the final 10 minutes, is kept under agitation by a magnetic stirrer (without any stirring at all); and
iii—The final drying step is done under vacuum at 70° C. (100° C.).

The content of the xylene soluble fraction is expressed as a percentage of the original 2.5 grams and then, by the difference in weight (complementary to 100), the xylene insoluble (X.I.) % is determined.

Molecular Weight Distribution (Mw/Mn)

Molecular weights and molecular weight distributions were measured at 150° C. using a Waters Alliance GPCV/2000 instrument equipped with four mixed-bed columns (PLgel Olexis) having a particle size of 13 μm. The dimensions of the columns were 300×7.8 mm. The mobile phase was vacuum distilled 1,2,4-trichlorobenzene (TCB) and the flow rate was kept at 1.0 ml/min. The sample solution was prepared by heating the sample under stirring at 150° C. in TCB for one to two hours. The concentration was 1 mg/ml. To prevent degradation, 0.1 g/l of 2,6-di-tert-butyl-p-cresol were added. 300 μl (nominal value) of solution were injected into the column set. A calibration curve was obtained using 10 polystyrene standard samples (EasiCal kit by Agilent) with molecular weights in the range from 580 to 7 500 000. It was assumed that the K values of the Mark-Houwink relationship were:

K=1.21×10⁴ dl/g and α=0.706 for the polystyrene standards, and

K=1.90×10⁴ dl/g and α=0.725 for the experimental samples.

A third-order polynomial fit was used for interpolating the experimental data and obtaining the calibration curve. Data acquisition and processing was done by using Waters Empowers 3 Chromatography Data Software with the GPC option.

Melt Flow Rate (MIL)

The melt flow rate (MIL) of the polymer was determined according to ISO 1133 (230° C., 2.16 kg).

¹³C NMR of Propylene/Ethylene Copolymers

¹³C NMR spectra were acquired on a Balker AV-600 spectrometer equipped with a cryoprobe, operating at 160.91 MHz in Fourier transform mode at 120° C.

The peak of the S_{ββ} carbon (nomenclature according to “Monomer Sequence Distribution in Ethylene-Propylene Rubber Measured by ¹³C NMR. 3. Use of Reaction Probability Mode,” C. J. Carman, R. A. Harrington and C. E. Wilkes, Macromolecules, 1977, 10, 536) was used as an internal reference at 29.9 ppm. The samples were dissolved in 1,1,2,2-tetrachloroethane-d2 at 120° C. with a 8% w/v concentration. Each spectrum was acquired with a 90° pulse, 15 seconds of delay between pulses and CPD to remove ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

PPP=100T_{ββ}/S PPE=100T_{βδ}/S EPE=100T_{δδ}/S PEP=100S_{ββ}/S PEE=100S_{βδ}/S EEE=100(0.25S_{γδ}+0.5S_{δδ})/S S=T_{ββ}+T_{βδ}+T_{δδ}+S_{ββ}+S_{βδ}+0.25S_{γδ}+0.5S_{δδ}

The molar percentage of the ethylene content was evaluated using the following equation:

E % mol=100*[PEP+PEE+EEE]. The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

Determination of the Regioinvertions:

Determined by means of ¹³C-NMR according to the methodology described by J. C. Randall in “Polymer sequence determination carbon-13 NMR method,” Academic Press (1977). The content of regioinvertions is calculated on the basis of the relative concentration of S_{αβ}+S_{ββ} methylene sequences.

Melting Temperature Via Differential Scanning Calorimetry (DSC)

The melting points of the polymers (Tm) were measured by Differential Scanning calorimetry (DSC) on a Perkin Elmer DSC-1 calorimeter, previously calibrated against indium melting points, and according to ISO 11357-1, 2009 and 11357-3, 2011, at 20° C./min. The weight of the samples in every DSC crucible was kept at 6.0±0.5 mg.

In order to obtain the melting point, the weighted sample was sealed into aluminum pans and heated to 200° C. at 20° C./minute. The sample was kept at 200° C. for 2 minutes to allow a complete melting of all the crystallites, then cooled to 5° C. at 20° C./minute. After standing 2 minutes at 5° C., the sample was heated for the second run time to 200° C. at 20° C./min. In this second heating run, the peak temperature (Tp,m) was taken as the melting temperature.

Seal Initiation Temperature (SIT)

Preparation of the Film Specimens

Some films with a thickness of 50 μm are prepared by extruding each test composition in a single screw Collin extruder (length/diameter ratio of screw 1:25) at a film drawing speed of 7 m/min and a melt temperature do 210-250° C. Each resulting film is superimposed on a 1000 μm thick film of a propylene homopolymer having a xylene insoluble fraction of 97 wt % and a MFR L of 2 g/10 min. The superimposed films are bonded to each other in a Carver press at 200° C. under a 9000 kg load, which is maintained for 5 minutes. The resulting laminates are stretched longitudinally and transversally, i.e. biaxially, by a factor 6 with a TOM Long film stretcher at 150° C., thus obtaining a 20 μm thick film (18 μm homopolymer+2 μm test). 2×5 cm specimens are cut from the films.

Determination of the SIT.

For each test two of the above specimens are superimposed in alignment, the adjacent layers being layers of the particular test composition. The superimposed specimens are sealed along one of the 2 cm sides with a Brugger Feinmechanik Sealer, Model HSG-ETK 745. Sealing time is 5 seconds at a pressure of 0.1 N/mm². The sealing temperature is increased of 2° C. for each seal, starting from about 10° C. less than the melting temperature of the test composition. The sealed samples are left to cool and then their unsealed ends are attached to an Instron machine where they are tested at a traction speed of 50 mm/min.

The SIT is the minimum sealing temperature at which the seal does not break when a load of at least 2 Newtons is applied in the said test conditions.

Determination of the Haze

50 μm film specimens prepared as described above for the SIT measure have been used. The haze value is measured using a Gardner photometric unit connected to a Hazemeter Type UX-10 or an equivalent instrument having a G.E. 1209 light source with filter “C”. Reference samples of known haze values are used for calibrating the instrument.

Determination of the Surface Tension.

The determination of the surface tension is measured according to ASTM D2578-09.

Procedure for the preparation of the spherical adduct

Microspheroidal MgCl₂.pC₂H₅OH adduct was prepared according to the method described in Comparative Example 5 of WIPO Pat. App. Pub. No. WO 98/44009, with the difference that BiCl₃ is in a powder form and in the amount of 3 mol % magnesium has been added before adding the oil. The adduct contains 11.2 wt % of Mg.

Procedure for the Preparation of the Solid Catalyst Component

Into a 300 L jacketed reactor, equipped with mechanical stirrer, condenser and thermocouple, 200 L of TiCl₄ were introduced at room temperature under a nitrogen atmosphere. After cooling to 0° C. and while stirring, diisobutylphthalate and 8 kg of the spherical adduct (prepared as described above) were sequentially added. The amount of charged internal donor was such to meet a Mg/donor molar ratio of 8. The temperature was raised to 100° C. and maintained for 1 hour. Thereafter, stirring was stopped, the solid product was allowed to settle and the supernatant liquid was siphoned off at 100° C. After the supernatant was removed, additional fresh TiCl₄ was added to reach the initial liquid volume again. The mixture was then heated at 120° C. and kept at this temperature for 0.5 hours. Stirring was stopped again, the solid was allowed to settle and the supernatant liquid was siphoned off at 120° C. The treatment with TiCl₄ at 120° C. was repeated with the same procedure as described above but the treatment time was decreased to 15 minutes. The solid was washed with anhydrous hexane six times using a temperature gradient down to 60° C. and one time at room temperature. The resulting solid was then dried under vacuum.

Propylene/Ethylene Copolymerization Examples 1-2

Prepolymerization Treatment

Before introducing it into the polymerization reactors, the solid catalyst component described above is subjected to prepolymerization by maintaining it in suspension in liquid propylene at 20° C. for about 5 minutes before introducing it into the polymerization reactor.

Polymerization

Copolymers are prepared by polymerizing propylene and ethylene in the presence of a catalyst under continuous conditions in a plant comprising a polymerisation apparatus as described in EP Pat. Doc. No. 1 012 195. The catalyst is sent to the polymerization apparatus that comprises two interconnected cylindrical reactors, a riser and a downcomer. Fast fluidization conditions are established in the riser by recycling gas from the gas-solid separator. In Examples 1-2 no barrier feed has been used. The powder is continuously discharged and dried under a nitrogen flow. The main polymerization conditions are reported in Table 1. The characterization of the polymer is reported in Table 4.

TABLE 1

| | | Ex. 1 | Ex 2 a |
|---|---|---|---|
| Catalyst feed | g/h | 10 | 10 |
| TEAL/DCPMS | g/g | 5 | 3 |
| Polymerization temperature | ° C. | 75 | 70 |
| Pressure | Bar-g | 28 | 27 |
| H2/C3 | mol/mol | 0.019 | 0.031 |
| C2/C2 + C3 | mol/mol | 0.023 | 0.028 |
| Residence time | min | 66 | 79 |

C2 = ethylene;
C3 = propylene;
H2 = hydrogen

### Comparative Examples 3-5

Comparative Examples 3-5 are from Examples 1, 3 and 4, respectively, of U.S. Pat. No. 6,365,685, in which XS has been determined according to the method given in the above characterization section. The results are reported in Table 2.

TABLE 2

| | Comparative | | |
|---|---|---|---|
| | Example | | |
| | 3 | 4 | 5 |
| C2 wt % | 2.3 | 4 | 6 |
| Xs wt % | 2.8 | 6.4 | 14.0 |
| C2x2.1-2.4 | 2.4 | 6.0 | 10.2 |

### Comparative Example 6

### Procedure for the Preparation of the Spherical Adduct

Microspheroidal MgCl₂.pC₂H₅OH adduct was prepared according to the method described in Comparative Example 5 of WIPO Pat. App. Pub. No. WO98/440091. The adduct contains 11.2 wt % of Mg.

### Procedure for the Preparation of the Solid Catalyst Component

The solid catalyst component has been prepared according to the method described above.

Polymerization

Before introducing it into the polymerization reactors, the solid catalyst component described above is subjected to prepolymerization by maintaining it in a suspension in liquid propylene at 20° C. for 8.8 min before introducing it into the polymerization reactor.

### Polymerization

Before introducing it into the polymerization reactors, the solid catalyst component described above is subjected to prepolymerization by maintaining it in a suspension in liquid propylene at 20° C. for 8.8 min before introducing it into the polymerization reactor.

The polymerization run is conducted in continuous mode in a series of two reactors equipped with devices to transfer the product from one reactor to the one immediately next to it. The two reactors are loop liquid phase reactors. Hydrogen is used as a molecular weight regulator. The gas phase (propylene, ethylene and hydrogen) is continuously analyzed via gas-chromatography. The polymerization conditions are reported in Table 3. The characterization of the polymer is reported on Table 4.

TABLE 3

| Loop reactor in liquid phase | |
|---|---|
| Catalyst feed g/h | 10 |
| Temperature, ° C. | 67 |
| Pressure, bar | 34 |
| Residence time, min | 81 |
| H₂ feed mol ppm | 1500 |
| C2 feed (kg/h) | 2.3 |
| C2− loop wt % | 3.3 |
| Xylene Solubles % | 6.3 |

C2 = ethylene;
C3 = propylene;
H2 = hydrogen

TABLE 4

| | | Example | | |
|---|---|---|---|---|
| | | 1 | 2 | Comp. Ex. 6 |
| MFR | g/10′ | 13.2 | 9.3 | 11.6 |
| C2 | % | 3.0 | 4.0 | 3.3 |
| XS | % | 3.2 | 5.2 | 6.2 |
| Mw/Mn | | 4.1 | 4.4 | >4.0 |
| C2x2.1-2.4 | | 3.9 | 6.0 | 4.53 |
| Tm | ° C. | 144.1 | 139.1 | 144.0 |
| Characterization | | | | |
| CAST film (50 | | | | |
| micron) | | | | |
| Haze | | % | 0.19 | 0.14 |
| SIT | ° C. | 123 | 118 | 124 |
| Ex | | 1 | 2 | Comp. Ex. 6 |

### Multilayer Film

The polymers of Examples 1-2 and Comparative Example 6 have been used to produce an A/B/A multilayer film, wherein the A layer comprises the polymers of the examples and the B layer is a propylene homopolymer, MOPLEN HP515M, sold by LyondellBasell. The film is 50 microns thick, wherein layer A is 20% of the overall thickness and layer B is 60% of the overall thickness. The processing parameters are reported in Table 5.

TABLE 5

| | | | | | | 1^{st} | 2^{nd} | | |
|---|---|---|---|---|---|---|---|---|---|
| | | | | | | chill | Chill | | Line |
| | | Barrel temperature | | | Die | roll | roll | Throughput | speed |
| | | (° C.) | | | | | | Kg/h | m/min |
| Layer A | Chill | 255 | 255 | 255 | 250 | 30 | 45 | 166 | 90 |
| (20) | roll | | | | | | | | |
| | treated | | | | | | | | |
| | outside | | | | | | | | |
| | roll | | | | | | | | |
| Layer B | Core | 240 | 250 | 250 | | | | 391 + 107 | |
| (60) | | | | | | | | | |
| Layer C | Internal | 250 | 255 | 255 | | | | 166 | |
| (20) | sealing | | | | | | | | |
| | inside | | | | | | | | |
| | roll | | | | | | | | |

Sample of the obtained films have been subjected to a corona treatment and then the surface tension has been measured after one week and after one month. The results are reported in Table 6.

TABLE 6

| | | Example | | |
|---|---|---|---|---|
| | | 1 | 2 | Comp. Ex. 6 |
| Surface | dyne/cm | 42 | 42 | 40 |
| tension after | | | | |
| one week | | | | |
| Surface | dyne/cm | 40 | 40 | 38 |
| tension after | | | | |
| one month | | | | |

As shown in Table 6, the films of the present disclosure exhibit a higher surface tension after one week and after one month versus comparative compositions. The improved compositions of the present disclosure allow for better printability of the resulting films even after a relatively long time, thus increasing the shelf life of the films of the present disclosure.

What is claimed is:

1. A multilayer film comprising at least a skin layer further comprising a propylene ethylene copolymer comprising:
an ethylene derived units content of between 1.0 wt % and 15.0% wt %;
a molecular weight distribution (MWD), expressed in terms of Mw/Mn, of greater than 4.0;
a content of xylene soluble fraction (XS) and an ethylene derived units content (C2) that fulfills the following relationship:
XS<1.0296·e^{0.435C2}
where XS is the percentage by weight of the fraction soluble in xylene at 25° C., and C2 is the percentage by weight of ethylene units in the copolymers as determined via NMR.

2. The multilayer film of claim 1, wherein in the propylene ethylene copolymer the ethylene content is between 2.2 and 7.1 wt %.

3. The multilayer film according of claim 1, wherein in the propylene ethylene copolymer the ethylene content is between 2.7 and 6.3 wt %.

4. The multilayer film claim 1, wherein in the propylene ethylene copolymer the melt flow rate (MFR, 230° C., 2.16 kg) ranges from 2 to 25 g/10 min.

5. The multilayer film of claim 1, wherein in the propylene ethylene copolymer the melt flow rate (MFR, 230° C., 2.16 kg) ranges from 3.0 to 20.0 g/10 min.

6. The multilayer film of claim 1, wherein the film comprises 3 to 11 layers.

7. The multilayer film of claim 1, wherein the film comprises 3 to 9 layers.

8. The multilayer film of claim 1, wherein the film comprises 3 to 7 layers.

9. The multilayer film of claim 1, wherein the film comprises 3 or 5 layers.

10. The multilayer film of claim 1, wherein the film comprises an A/B/A or A/B/C structure and the A component is the propylene/ethylene copolymer of claim 1.
